(19) United States
(12) Patent Application Publication
(10) Pub. No.: US 2026/0283179 A1
(43) Pub. Date: Sep. 24, 2026

(54) A FAT COMPOSITION COMPRISING A VEGETABLE FAT PHASE WHICH IS FREE FROM PALM OIL AND/OR FRACTIONS THEREOF AND WHEREIN THE VEGETABLE FAT PHASE ORIGINATES FROM AT LEAST TWO DIFFERENT VEGETABLE FAT SOURCES

(71) Applicant: AAK AB (PUBL), Malmö (SE)

(72) Inventor: Morten Daugaard ANDERSEN, Aarhus C (DK)

(21) Appl. No.: 19/477,132

(22) PCT Filed: Apr. 25, 2024
(86) PCT No.: PCT/SE2024/050395

§ 371 Date: Oct. 21, 2025

(30) Foreign Application Priority Data
Apr. 28, 2023 (SE) 2350515-9

(51) Int. Cl. A23D 9/04; A23G 1/38

(52) U.S. Cl. CPC A23D 9/04; A23G 1/38

(57) ABSTRACT

Disclosed is a fat composition comprising a vegetable fat phase, wherein the vegetable fat phase is free from palm oil and/or fractions thereof and wherein the vegetable fat phase originates from at least two different vegetable fat sources. The present disclosure also relates to the use of the fat composition, a confectionary or chocolate or chocolate-like product comprising the fat composition and a process for preparation of the fat composition. A fat composition as disclosed shows the possibility to produce chocolate-like compounds without the use of a palm based vegetable fat phase without compromising the quality.

### TECHNICAL FIELD OF THE INVENTION

The present invention relates to a fat composition comprising a vegetable fat phase, wherein the vegetable fat phase is free from palm oil and/or fractions thereof and wherein the vegetable fat phase originates from at least two different vegetable fat sources. The present disclosure also relates to the use of the fat composition, a confectionary or chocolate or chocolate-like product comprising the fat composition and a process for preparation of the fat composition.

### BACKGROUND OF THE INVENTION

Palm oil is an extremely versatile oil that has many different properties and functions that makes it so useful and so widely used. It is semi-solid at room temperature so it can keep spreads spreadable; it is resistant to oxidation so it can give products a longer shelf-life; it's stable at high temperatures so it helps to give fried products a crispy and crunchy texture; and it's also odourless and colourless so it doesn't alter the look or smell of food products.

As well as being versatile, compared to other vegetable oils the oil palm is a very efficient crop, able to produce high quantities of oil over small areas of land, almost all year round. This makes it an attractive crop for growers and smallholders, who can rely on the steady income that palm oil provides.

Palm oil is also found as an important component in cocoa butter equivalents (CBEs) and in cocoa butter improvers (CBI's) used in the chocolate industry today. In CBE components palm mid fractions is used as one of the more important components.

Unfortunately, palm oil has been and continues to be a major driver of deforestation of some of the world's most biodiverse forests, destroying the habitat of already endangered species like the Orangutan, pygmy elephant, and Sumatran rhino. This forest loss coupled with conversion of carbon rich peat soils are throwing out millions of tonnes of greenhouse gases into the atmosphere and contributing to climate changes. There also remains some exploitation of workers and child labour. These are serious issues that the whole palm oil sector needs to address.

Therefore, non-palm oil sources in the vegetable oils and fats industry have become an important subject as an alternative to oil palms. Thus, there is a need in the art for such alternatives.

Accordingly, the main object of the invention is to provide such alternatives.

### SUMMARY OF THE INVENTION

The present invention relates to fat composition comprising a vegetable fat phase, wherein the vegetable fat phase comprises:
from 85.0% to 100.0% by weight of triglycerides compared to the total weight of the vegetable fat phase;
from 50.0% to 85.0% by weight of SatOSat+SatSatO triglycerides compared to the total weight of triglycerides in the vegetable fat phase;
from 40.0 to 65.0% by weight of StOSt+StStO triglycerides compared to the total weight of triglycerides in the vegetable fat phase;
4.0% or less by weight of POP+PPO triglycerides compared to the total weight of triglycerides in the vegetable fat phase;
from 4.0% to 13.0% by weight of StOA+StAO+AStO triglycerides compared to the total weight of triglycerides in the vegetable fat phase;
from 2.0% to 6.0% by weight of StLiSt+StStLi triglycerides compared to the total weight of triglycerides in the vegetable fat phase; and a ratio of the weight of SatSatO triglycerides to the weight of SatOSat triglycerides of 0.10 or less;
   wherein the vegetable fat phase is free from palm oil and/or fractions thereof;
   wherein the vegetable fat phase originates from at least two different vegetable fat sources; and
   wherein Sat is saturated fatty acids selected from C16-, C18-, C20-, C22-, and/or C24-fatty acids, P is palmitic acid (C16:0), St is steric acid (C18:0), O is oleic acid (C18:1), A is arachidic acid (C20:0), and Li is linoleic acid (C18:2).

The fat composition as disclosed herein shows the possibility to produce chocolate-like compounds without the use of a palm-based vegetable fat phase without compromising the quality. Such product will give the consumers a choice for buying chocolate-like compounds that does not comprise palm oil and/or fractions thereof.

As can be seen by the examples provided herein, it is possible to make a chocolate comprising CBI based on non-palm oil sources, where the resulting chocolate or chocolate-like products is as bloom stable as a product made with only cocoa butter. This means that the present invention as disclosed herein can be used to produce chocolate-like compounds, which are as bloom stable as traditional chocolate or chocolate-like compounds.

Further, the present invention is low or absent of asymmetric (SatSatO) TAGs in the CBI. This has an added advantage, since the presence of asymmetric TAG's generally result in lower temperature settings in the crystallization and outlet zone of a temper unit, which can have a negative impact to crystallization in the cooling tunnel. Furthermore, a minor impact to texture towards a softer product can also be a consequence of the presence of asymmetric mono-saturated TAGs in the fat composition.

The present invention also relates to use of the fat composition according to the present invention for bakery, dairy, or confectionary applications, or in coating or enrobing for nuts, bakery or confectionary applications, such as bakery or confectionary application, selected from biscuit, cake, muffin, donut, pastry, or bread applications; or for chocolate and chocolate-like applications, such as chocolate and chocolate-like coatings, or chocolate and chocolate-like moulding, such as tablet moulding.

Further disclosed is also a confectionary or chocolate or chocolate-like product having a fat content from 20% to 60% by weight, where the fat content comprises from 5 to 50% by weight of a fat composition according to the present invention compared to the total weight of the fat content.

A process for the preparation of a fat composition according to the present invention, wherein the first vegetable fat source is blended with the second vegetable fat source to obtain the fat composition is also disclosed herein.

### Definitions

In the context of the present invention, the following terms are meant to comprise the following, unless defined elsewhere in the description.

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant origin or single cell organism origin.

As used herein, the term “triglycerides” may be used interchangeably with the term “triacylglycerides” and should be understood as an ester derived from glycerol and three fatty acids. “Triglycerides” may be abbreviated TG or TAG.

Saturated fatty acids (SAFA) are chains of carbon atoms joined by single bonds, with the maximum number of hydrogen atoms attached to each carbon atom in the chain. Unsaturated fatty acids are chains of carbon atoms joined by single bonds and varying numbers of double bonds, which do not have their full quota of hydrogen atoms attached. An unsaturated fatty acid can exist in two forms, the cis form and the trans form. A double bond may exhibit one of two possible configurations: trans or cis. In trans configuration (a trans fatty acid) the carbon chain extends from opposite sides of the double bond, whereas, in cis configuration (a cis fatty acid) the carbon chain extends from the same side of the double bond.

By using the nomenclature CX means that the fatty acid comprises X carbon atoms, e.g. a C14 fatty acid has 14 carbon atoms while a C8 fatty acid has 8 carbon atoms.

By using the nomenclature CX: Y means that the fatty acid comprises X carbon atoms and Y double bonds, e.g. a C14:0 fatty acid has 14 carbon atoms and 0 double bonds while a C18:1 fatty acid has 18 carbon atoms and 1 double bond.

In general, triglycerides use a “sn” notation, which stands for stereospecific numbering. In a Fischer projection of a natural L-glycerol derivative, the secondary hydroxyl group is shown to the left of C-2; the carbon atom above this then becomes C-1 and that below becomes C-3. The prefix ‘sn’ is placed before the stem name of the compound.

### Sn1/sn2/sn3:

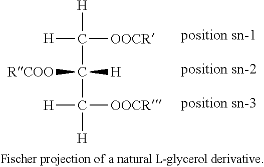

By randomly distributed is meant that the fatty acids are randomly distributed to the three sn-positions. A randomly distributed composition may be obtained by means of esterification, chemical transesterification or enzymatic transesterification. All naturally occurring fat compositions, e.g. virgin olive oil, palm kernel oil, coconut oil or rapeseed oil all have a non-randomly distribution of the fatty acids on the glycerol backbone.

By vegetable fat phase is meant a combination of at least two different vegetable fat sources originating from a plant or a single cell organism. The vegetable fat phase can e.g. be selected from the group of Shea oil, or Sal oil, or a blend thereof, and/or fractions thereof. It can also be selected from an interesterified, fractionated, and/or hydrogenated version of Shea, and/or Sal oil, or a blend thereof, and/or fractions thereof.

As used herein, “%” or “percentage” relates to weight percentage i.e. wt. % or wt.-% if nothing else is indicated.

The sum of a given component in the vegetable fat composition can never be more than 100% by weight, e.g. the sum of all the fatty acid in the vegetable fat composition can never be more than 100% by weight.

As used herein, “oil” and “fat” are used interchangeably, unless otherwise specified.

As used herein, “vegetable oil” and “vegetable fat” are used interchangeably, unless otherwise specified.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

As used herein “cocoa butter equivalent” or CBE is intended to mean an edible fat having very similar chemical and physical properties and being compatible with cocoa butter. In both cocoa butter and cocoa butter equivalent, the main fatty acids are typically palmitic, stearic, and oleic acids. The triglycerides are typically 2-oleo di-saturated (SatOSat (Sat2O)). Despite their similarity to cocoa butter, cocoa butter equivalents can be detected in chocolate by their triglyceride ratios, which are appreciably different from those in cocoa butter.

As used herein “cocoa butter improver” or CBI is intended to mean a harder version (i.e. has a higher solid fat content) of cocoa butter equivalent due to a higher content of high melting SatOSat triglycerides such as StOSt triglycerides and/or StOA triglycerides. It is usually used in chocolate formulations having a high content of milk fat or those meant for tropical climates. It improves the heat stability of soft cocoa butter varieties, adds more solid fat and thereby increases hardness in chocolate products.

As used herein “edible” is something that is suitable for use as food or as part of a food product, such as a dairy, chocolate, or confectionary product.

For products and methods in the confectionery areas, reference is made to “Chocolate, Cocoa and Confectionery”, B. W. Minifie, Aspen Publishers Inc., 3. Edition 1999.

A food product is a product for human consumption.

By a chocolate or chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like product may be produced with a low amount of or even without cocoa butter, e.g. by replacing the cocoa butter with a cocoa butter equivalent, cocoa butter substitute, etc. In addition, many chocolate or chocolate-like products comprise cocoa powder or cocoa mass, although some chocolate or chocolate-like products, such as typical white chocolates, may be produced without cocoa powder, but e.g. drawing its chocolate taste from cocoa butter. Depending on the country and/or region there may be various restrictions on which products may be marketed as chocolate.

By compound is meant a product made from a combination of cocoa butter and (vegetable) fats. A compound may also comprise milk fat in various amounts. It is used as a lower-cost alternative to true chocolate, as it uses less-expensive hard (vegetable) fats in place of the more expensive cocoa butter. It may also be known as “compound coating” or “chocolatey coating” when used as a coating for confectionary or candy.

The term “comprising” or “to comprise” is to be interpreted as specifying the presence of the stated parts, steps, features, or components, but does not exclude the presence of one of more additional parts, steps, features, or components.

As used herein, the term “and/or” is intended to mean the combined (“and”) and the exclusive (“or”) use, i.e. “A and/or B” is intended to mean “A alone, or B alone, or A and B together”.

### DETAILED DESCRIPTION OF THE INVENTION

When describing the below embodiments, the present invention envisages all possible combinations and permutations of the below described embodiments with the above disclosed aspects.

The invention relates to a fat composition comprising a vegetable fat phase, wherein the vegetable fat phase comprises:
from 85.0% to 100.0% by weight of triglycerides compared to the total weight of the vegetable fat phase;
from 50.0% to 85.0% by weight of SatOSat+SatSatO triglycerides compared to the total weight of triglycerides in the vegetable fat phase;
from 40.0 to 65.0% by weight of StOSt+StStO triglycerides compared to the total weight of triglycerides in the vegetable fat phase;
4.0% or less by weight of POP+PPO triglycerides compared to the total weight of triglycerides in the vegetable fat phase;
from 4.0% to 13.0% by weight of StOA+StAO+AStO triglycerides compared to the total weight of triglycerides in the vegetable fat phase;
from 2.0% to 6.0% by weight of StLiSt+StStLi triglycerides compared to the total weight of triglycerides in the vegetable fat phase; and
a ratio of the weight of SatSatO triglycerides to the weight of SatOSat triglycerides of 0.10 or less;
   wherein the vegetable fat phase is free from palm oil and/or fractions thereof;
   wherein the vegetable fat phase originates from at least two different vegetable fat sources; and
   wherein Sat is saturated fatty acids selected from C16-, C18-, C20-, C22-, and/or C24-fatty acids, P is palmitic acid (C16:0), St is steric acid (C18:0), O is oleic acid (C18:1), A is arachidic acid (C20:0), and Li is linoleic acid (C18:2).

The fat composition as disclosed herein shows the possibility to produce chocolate-like compounds without the use of a palm-based vegetable fat phase without compromising the quality.

The fat composition as disclosed herein can be used to produce chocolate-like compounds based on non-palm oil sources, which are as bloom stable as a product made with only cocoa butter or even better.

Furthermore, some of the SFC profiles for the compositions (also referred to as blends) disclosed herein are similar to the SFC profile for cocoa butter, strongly indicating the potential of the fat compositions as a partial substitute for cocoa butter in a chocolate application.

In one or more embodiments, the vegetable fat phase is free from enzymatic interesterified components. Hence, this means that in one or more embodiments the vegetable fat phase is made without the use of 1-3 specific enzymatic interesterification. The fat composition as disclosed herein therefore also shows the possibility to produce chocolate-like compounds without the use of a 1-3 specific enzymatic interesterification without compromising the quality.

In one or more embodiments, the vegetable fat phase comprises from 95.0% to 99.0% by weight of triglycerides compared to the total weight of the vegetable fat phase.

In one or more embodiments, the vegetable fat phase comprises from 55.0% to 82.0% by weight of SatOSat+SatSatO triglycerides compared to the total weight of triglycerides in the vegetable fat phase, such as from 57.0% to 80.0% by weight, or such as from 60.0% to 77.0% by weight of SatOSat+SatSatO triglycerides compared to the total weight of triglycerides in the vegetable fat phase.

In one or more embodiments, the vegetable fat phase comprises from 42.0% to 63.0% by weight of StOSt+StStO triglycerides compared to the total weight of triglycerides in the vegetable fat phase, such as from 45.0% to 61.0% by weight of StOSt+StStO triglycerides compared to the total weight of triglycerides in the vegetable fat phase.

In one or more embodiments, the vegetable fat phase comprises 3.0% or less by weight of POP+PPO triglycerides compared to the total weight of triglycerides in the vegetable fat phase, such as 2.0% or less by weight, or such as 1.2% or less by weight of POP+PPO triglycerides compared to the total weight of triglycerides in the vegetable fat phase.

In one or more embodiments, the vegetable fat phase further comprises from 4.0% to 15.0% by weight of POSt+PStO+StPO triglycerides compared to the total weight of triglycerides in the vegetable fat phase, such as from 5.0% to 10.0% by weight, or such as from 6.0% to 9.5% by weight of POSt+PStO+StPO triglycerides compared to the total weight of triglycerides in the vegetable fat phase.

In one or more embodiments, the vegetable fat phase comprises from 5.0% to 12.0% by weight of StOA+StAO+AStO triglycerides compared to the total weight of triglycerides in the vegetable fat phase, such as from 6.0% to 10.5% by weight, or such as from 6.0% to 9.0% by weight of StOA+StAO+AStO triglycerides compared to the total weight of triglycerides in the vegetable fat phase.

In one or more embodiments, the vegetable fat phase comprises from 2.2% to 5.8% by weight of StLiSt+StStLi triglycerides compared to the total weight of triglycerides in the vegetable fat phase, such as from 2.5% to 5.5% by weight of StLiSt triglycerides compared to the total weight of triglycerides in the vegetable fat phase.

In one or more embodiments, wherein the ratio in the vegetable fat phase of the weight of SatSatO triglycerides to the weight of SatOSat triglycerides is 0.07 or less, 0.04 or less, 0.02 or less, or 0.01 or less.

In one or more embodiments, the ratio in the vegetable fat phase of the weight of SatSatO triglycerides to the weight of SatOSat triglycerides is from 0.00 to 0.10, such as from 0.00 to 0.07, such as from 0.00 to 0.04, such as from 0.00 to 0.02, or such as from 0.00 to 0.01.

The examples clearly demonstrate that a composition comprising a vegetable fat source originating from Shea oil and/or fractions thereof and a vegetable fat source originating from Sal oil and/or fractions thereof can be used as an alternative to palm fractions to make non-palm CBI compositions.

In one or more embodiments, the at least two different vegetable fat sources are composed of at least a first vegetable fat source and a second vegetable fat source; wherein the first vegetable fat source is originating from Shea oil and/or fractions thereof; and wherein the second vegetable fat source is originating from Sal oil and/or fractions thereof.

In one or more embodiments, the first vegetable fat source is originating from Shea oil; and wherein the second vegetable fat source is originating from Sal oil and/or fractions thereof.

In one or more embodiments, the first vegetable fat source is originating from Shea oil and/or fractions thereof; and wherein the second vegetable fat source is originating from Sal oil.

In one or more embodiments, the first vegetable fat source is originating from Shea oil; and wherein the second vegetable fat source is originating from Sal stearin.

In one or more embodiments, the first vegetable fat source is originating from Shea stearin; and wherein the second vegetable fat source is originating from Sal oil.

In one or more embodiments, the first vegetable fat source is in an amount from 30% to 70% by weight of the sum of the first vegetable fat source and the second vegetable fat source.

In one or more embodiments, the second vegetable fat source is in an amount from 30% to 70% by weight of the sum of the first vegetable fat source and the second vegetable fat source.

In one or more embodiments, the vegetable fat phase originates from and consist of two different vegetable fat sources.

In one or more embodiments, the fat composition is a cocoa butter improver (CBI) composition.

Cocoa butter improvers are e.g. normally made from a mix of palm mid fraction and a fractionated part of shea stearin or another oil fraction rich in SatOSat triglycerides, where Sat is a saturated fatty acid having a chain length of C16 or longer, such as C16 and C18. However, by the present invention, it has shown to be possible to make non-palm cocoa butter improvers.

The CBI's disclosed herein shows an increase in heat related bloom stability (better shelf life at 25° C. in the examples).

Use of the fat composition according to the present invention for bakery, dairy, or confectionary applications, or in coating or enrobing for nuts, bakery or confectionary applications, such as bakery or confectionary application, selected from biscuit, cake, muffin, donut, pastry, or bread applications; or for chocolate and chocolate-like applications, such as chocolate and chocolate-like coatings is also disclosed, or chocolate and chocolate-like moulding, such as tablet moulding is also disclosed.

In one or more embodiments, use of the fat composition according to the present disclosure for molded applications such as tablets is also disclosed.

Further disclosed is also a confectionary or chocolate or chocolate-like product having a fat content from 20% to 60% by weight, where the fat content comprises from 5 to 50% by weight of a fat composition according to the present disclosure compared to the total weight of the fat content.

In one or more embodiments, the fat content comprises from 10% to 40% by weight of the fat composition, such as from 15% to 35% by weight of the fat composition compared to the total weight of the fat content.

A process for the preparation of a fat composition according to the present disclosure is also disclosed herein, wherein the process comprises that the first vegetable fat source is blended with the second vegetable fat source to obtain the fat composition.

The present invention is further illustrated by the following examples, which are not to be construed as limiting the scope of protection.

### EXAMPLES

### Example 1-CBI Compositions

Table 1 displays a typical selected triglyceride composition for a Shea oil, shea stearin IV 36, Sal oil, Sal Stearin and West Africa cocoa butter measured by AOCS method Ce 5b-89. The asymmetric isomers are included in the amount specified under each TAGs in the examples since the method used (AOCS Ce 5b-89) does not measure the difference in isomeric state of a TAG. Hence, for example, when there is written POSt in the tables it also includes its isomers; PStO and StPO.

The content of SatSatO was determined using a well-known method by a commercial laboratory. The amount of the asymmetric SatSatO isomer is measured using an absolute method. Thereafter, the triglyceride ratioSatSatO/SatOSat was calculated.

The solid fat content measured by IUPAC 2.150b is also displayed in Table 1.

TABLE 1

| | | | | |
|---|---|---|---|---|
| | Shea | | | |
| Shea | Stearin | Sal | Sal | Cocoa |
| Oil | IV 36 | Oil | Stearin | butter |

Triglyceride composition*

| | | | | | |
|---|---|---|---|---|---|
| MOP/wt. % | — | 0.1 | 0.1 | — | 0.2 |
| POP/wt. % | 0.3 | 1.3 | 0.8 | 0.8 | 15.2 |
| POSt/wt. % | 4.7 | 7.4 | 10.3 | 11.2 | 37.8 |
| StOSt/wt. % | 38.0 | 67.3 | 44.5 | 58.4 | 27.1 |
| StOA/wt. % | 2.1 | 3.6 | 11.9 | 15.5 | 1.5 |
| AOA/wt. % | 0.2 | 0.3 | 1.7 | 2.2 | 0.3 |
| StLiSt/wt. % | 5.5 | 7.0 | 1.8 | 1.4 | 2.0 |
| Total | 45.3 | 80.0 | 69.3 | 88.1 | 82.1 |
| SatOSat/wt. % | | | | | |

Triglyceride position ratio

| | | | | | |
|---|---|---|---|---|---|
| SatSatO/SatOSat | 0.00 | 0.00 | 0.00 | 0.00 | 0.00 |

Solid fat content (SFC)

| | | | | | |
|---|---|---|---|---|---|
| SFC (20° C.) | 39.7 | 85.4 | 58.7 | 86.9 | 76.3 |
| SFC (25° C.) | 37.4 | 83.9 | 56.6 | 83.2 | 69.9 |
| SFC (30° C.) | 30.6 | 79.8 | 46.9 | 68.5 | 46.6 |
| SFC (35° C.) | 8.1 | 65.5 | 4.3 | 28.6 | 1.0 |
| SFC (40° C.) | 1.0 | 2.6 | <0.5 | 0.6 | <0.5 |

*Measured using AOCS Ce5b-89

Table 2 shows the selected triglyceride composition of West African cocoa butter compared to four CBIs made of blends of Shea stearin and Sal oil.

TABLE 2

| | | | | |
|---|---|---|---|---|
| Cocoa | | | | |
| Butter | CBI I | CBI II | CBI III | CBI IV |

Component

| | | | | | |
|---|---|---|---|---|---|
| West African | 100.0 | — | — | — | — |
| cocoa butter/ | | | | | |
| wt. % | | | | | |
| Shea Stearin IV | — | 70.0 | 60.0 | 50.0 | 40.0 |
| 36/wt. % | | | | | |
| Sal oil/wt. % | — | 30.0 | 40.0 | 50.0 | 60.0 |

Triglyceride composition*

| | | | | | |
|---|---|---|---|---|---|
| MOP/wt. % | 0.2 | 0.1 | 0.1 | 0.1 | 0.1 |
| POP/wt. % | 15.2 | 1.2 | 1.1 | 1.1 | 1.0 |
| POSt/wt. % | 37.8 | 8.3 | 8.6 | 8.9 | 9.1 |
| StOSt/wt. % | 27.1 | 60.5 | 58.2 | 55.9 | 53.6 |
| StOA/wt. % | 1.5 | 6.1 | 6.9 | 7.8 | 8.6 |
| AOA/wt. % | 0.3 | 0.7 | 0.9 | 1.0 | 1.1 |
| StLiSt/wt. % | 2.0 | 5.4 | 4.9 | 4.4 | 3.9 |
| Total SatOSat/ | 82.1 | 76.8 | 75.7 | 74.7 | 73.6 |
| wt. % | | | | | |

Triglyceride position isomer

| | | | | | |
|---|---|---|---|---|---|
| SatSatO/SatOSat | 0.00 | 0.00 | 0.00 | 0.00 | 0.00 |

Solid fat content (SFC)

| | | | | | |
|---|---|---|---|---|---|
| SFC (20° C.) | 76.3 | 78.8 | 75.1 | 73.1 | 70.2 |
| SFC (25° C.) | 69.9 | 77.9 | 74.0 | 72.0 | 68.8 |
| SFC (30° C.) | 46.6 | 74.0 | 69.3 | 66.3 | 58.3 |
| SFC (35° C.) | 1.0 | 51.5 | 44.1 | 39.0 | 26.6 |
| SFC (40° C.) | <0.5 | 1.5 | 0.8 | <0.5 | <0.5 |

*Measured using AOCS Ce5b-89

There are large differences in the SatOSat composition between cocoa butter and the CBI I to IV. The POP and POSt content is significantly lower for the CBI's whereas the StOSt and StOA contents is higher for the CBI's compared to cocoa butter. This is the main reason for the differences in the SFC melting profiles between the CBI's and cocoa butter as well. The CBI's have significantly higher SFC at 30 and 35° C. as compared to cocoa butter.

Table 3 shows the selected triglyceride composition of West African cocoa butter compared to four CBEs made of blends of Shea oil and Sal stearin.

TABLE 3

| | | | | |
|---|---|---|---|---|
| Cocoa Butter | CBI V | CBI VI | CBI VII | CBI VIII |

Component

| | | | | | |
|---|---|---|---|---|---|
| West African cocoa butter/ | 100.0 | — | — | — | — |
| wt. % | | | | | |
| Sal Stearin/wt. % | — | 70.0 | 60.0 | 50.0 | 40.0 |
| Shea oil/wt. % | — | 30.0 | 40.0 | 50.0 | 60.0 |

Triglyceride composition*

| | | | | | |
|---|---|---|---|---|---|
| MOP/wt. % | 0.2 | 0.3 | 0.3 | 0.3 | 0.2 |
| POP/wt. % | 15.2 | 0.7 | 0.6 | 0.6 | 0.5 |
| POSt/wt. % | 37.8 | 9.3 | 8.6 | 6.0 | 7.3 |
| StOSt/wt. % | 27.1 | 52.3 | 50.2 | 48.2 | 46.2 |
| StOA/wt. % | 1.5 | 11.5 | 10.1 | 8.8 | 7.5 |
| AOA/wt. % | 0.3 | 1.6 | 1.4 | 1.2 | 1.0 |
| StLiSt/wt. % | 2.0 | 2.6 | 3.0 | 3.5 | 3.9 |
| Total SatOSat/wt. % | 82.1 | 75.3 | 71.0 | 66.7 | 62.4 |

Triglyceride position isomer

| | | | | | |
|---|---|---|---|---|---|
| SatSatO/SatOSat | 0.00 | 0.00 | 0.00 | 0.00 | 0.00 |

Solid fat content (SFC)

| | | | | | |
|---|---|---|---|---|---|
| SFC (20° C.) | 76.3 | 73.3 | 68.0 | 63.2 | 58.2 |
| SFC (25° C.) | 69.9 | 71.8 | 66.2 | 61.2 | 56.2 |
| SFC (30° C.) | 46.6 | 64.2 | 58.3 | 53.2 | 48.4 |
| SFC (35° C.) | 1.0 | 29.4 | 23.4 | 17.4 | 14.1 |
| SFC (40° C.) | <0.5 | <0.5 | <0.5 | <0.5 | 0.5 |

*Measured using AOCS Ce5b-89

As were the case for CBI I to IV compared to cocoa butter (Table 2) there are large differences in the SatOSat composition between cocoa butter and the CBI V to VIII. The POP and POSt content is significantly lower for the CBI's whereas the StOSt and StOA contents is higher for the CBI's compared to cocoa butter. This is the main reason for the differences in the SFC melting profiles between the CBI's and cocoa butter as well. The CBI's have significantly higher SFC at 30 and 35° C. as compared to cocoa butter albeit the SFC at 35° C. is lower than the corresponding SFC at 35° C. for CBI I to IV.

Several fat blends of cocoa butter and CBI I to VIII were made. Table 4 shows the SFC profiles for blends of 15.0 and 30.0% CBI with Cocoa butter for a CBI I to VIII.

TABLE 4

| | | | | | |
|---|---|---|---|---|---|
| 15.0% | 30.0% | 15.0% | 30.0% | 15.0% | 30.0% |
| CBI I + | CBI I + | CBI II + | CBI II + | CBI III + | CBI III + |
| 85.0% CB | 70.0% CB | 85.0% CB | 70.0% CB | 85.0% CB | 70.0% CB |

Solid fat content (SFC)

| SFC (20° C.) | 74.8 | 74.6 | 73.8 | 73.5 | 73.8 | 72.7 |
|---|---|---|---|---|---|---|
| SFC (25° C.) | 69.0 | 70.8 | 68.6 | 69.3 | 68.0 | 68.4 |
| SFC (30° C.) | 51.7 | 59.0 | 51.3 | 57.1 | 50.3 | 56.2 |
| SFC (35° C.) | 3.1 | 12.7 | 2.4 | 10.8 | 2.5 | 9.3 |
| SFC (40° C.) | <0.5 | <0.5 | <0.5 | <0.5 | <0.5 | <0.5 |
| | 15.0% | 30.0% | 15.0% | 30.0% | 15.0% | 30.0% |
| | CBI IV + | CBI IV + | CBI V + | CBI V + | CBI VI + | CBI VI + |
| | 85.0% CB | 70.0% CB | 85.0% CB | 70.0% CB | 85.0% CB | 70.0% CB |

Solid fat content (SFC)

| | | | | | | |
|---|---|---|---|---|---|---|
| SFC (20° C.) | 74.0 | 71.9 | 74.7 | 73.6 | 74.2 | 72.0 |
| SFC (25° C.) | 67.7 | 67.6 | 68.8 | 69.0 | 67.7 | 66.8 |
| SFC (30° C.) | 50.0 | 54.8 | 50.5 | 55.3 | 49.1 | 52.3 |
| SFC (35° C.) | 2.0 | 8.4 | 1.6 | 8.1 | 1.6 | 7.0 |
| SFC (40° C.) | <0.5 | <0.5 | <0.5 | <0.5 | <0.5 | <0.5 |

| | | | |
|---|---|---|---|
| 15.0% | 30.0% | 15.0% | 30.0% |
| CBI VII + | CBI VII + | CBI VIII + | CBI VIII + |
| 85.0% CB | 70.0% CB | 85.0% CB | 70.0% CB |

Solid fat content (SFC)

| | | | | |
|---|---|---|---|---|
| SFC (20° C.) | 73.4 | 70.8 | 72.5 | 69.4 |
| SFC (25° C.) | 67.0 | 64.7 | 65.6 | 62.5 |
| SFC (30° C.) | 48.2 | 49.7 | 46.9 | 47.0 |
| SFC (35° C.) | 1.6 | 5.0 | 1.8 | 4.7 |
| SFC (40° C.) | <0.5 | <0.5 | <0.5 | <0.5 |

A comparison of the SFC profiles for the CBI I to VIII and for the blends of CBI I to VIII with cocoa butter it's clear that the SFC at 35° C. is decreased significantly in the CBI and Cocoa butter blends. Furthermore, the SFC profiles for the blends based on 15% CBI and 85% Cocoa butter are similar to the SFC profile for cocoa butter, strongly indicating the potential of CBI I to Vill as a partial substitute for cocoa butter in a chocolate application.

The increase in SFC at 35° C. for the blends with 30% CBI and 70% cocoa butter indicate that the sensory perception for such a fat composition in a chocolate application may be perceived as slightly waxier as compared to a cocoa butter based analogue application.

### Example 2: Recipes and Manufacture of Dark Chocolate Applications with CBI Compositions

The procedure of the dark chocolate productions were all done following this procedure: All ingredients, except lecithin and some of the fat, are mixed on a teddy mixer with heat jacket to a consistency of marzipan. Afterwards, the mixture is refined on a three-roller Bühler refiner to an average particle size of 20 micron. The mass is then dry-conched for 3 hours at 65° C. for three hours before the remaining fat is added and then followed by wet-couching for 3 hours. Half an hour before conching is complete lecithin is added. The chocolates are then transferred to an Aasted AMC 50 three zone tempering machine to be optimally tempered.

The dark chocolates are deposited into 50 g preheated molds and placed in a three-zone cooling tunnel for 30 minutes. Temperatures are adjusted to 15° C. in zone 1 and 3 and 12° C. in zone 2. The demolded chocolate tablets are kept at 20° C. for one week and then moved to 20° C. and 25° C. cabinets for isothermal storage. Once a week the tablets are evaluated by a trained panel of experts for visible bloom. The number of weeks until the appearance of strong bloom on the surface of the chocolate tablets are noted as the shelf life result (see table 7 below).

Dark chocolate recipe and fat composition are given in Table 5.

TABLE 5

| Chocolate reference and chocolates with CBI's | | | | |
|---|---|---|---|---|
| | 15% | 30% | 15% | 30% |
| Cocoa | CBI I + | CBI I + | CBI VIII + | CBI VIII + |
| Butter | 85% CB | 70% CB | 85% CB | 70% CB |

Recipe

| | | | | | |
|---|---|---|---|---|---|
| Sugar/wt. % | 49.58 | 49.58 | 49.58 | 49.58 | 49.58 |
| Cocoa powder (11% | 15.00 | 15.00 | 15.00 | 15.00 | 15.00 |
| CB)/wt. % | | | | | |
| Skim milk powder/wt. % | 5.00 | 5.00 | 5.00 | 5.00 | 5.00 |
| Lecithin/wt. % | 0.4 | 0.4 | 0.4 | 0.4 | 0.4 |
| Vanillin/wt. % | 0.02 | 0.02 | 0.02 | 0.02 | 0.02 |
| Cocoa butter/wt. % | 30.00 | 25.2 | 20.5 | 25.2 | 20.5 |
| CBE I/wt. % | — | 4.8 | 9.5 | — | — |
| CBE VIII/wt. % | — | — | — | 4.8 | 9.5 |
| Total fat content/wt. % | 31.7 | 31.7 | 31.7 | 31.7 | 31.7 |

Fat composition

| | | | | | |
|---|---|---|---|---|---|
| Cocoa butter/wt. % | 99.8 | 84.7 | 69.8 | 84.7 | 69.8 |
| CBE I/wt. % | — | 15.1 | 30.0 | — | — |
| CBE VIII/wt. % | — | — | | 15.1 | 30.0 |
| Milk fat/wt. % | 0.2 | 0.2 | 0.2 | 0.2 | 0.2 |

### Example 3—Sensory Evaluation

The 50 g tablets were tasted by a trained sensory panel and evaluated for meltdown using the scale below:
A Good and clean meltdown. Comparable to cocoa butter-based chocolate
B. Acceptable meltdown. Slightly waxy meltdown but close to cocoa-butter based chocolate
C. Inferior meltdown. Waxy meltdown not comparable to cocoa butter-based chocolate

TABLE 6

| Chocolate reference and chocolates with CBE's | | | | |
|---|---|---|---|---|
| | 15% | 30% | 15% | 30% |
| Cocoa | CBI I + | CBI I + | CBI VIII + | CBI VIII + |
| Butter | 85% CB | 70% CB | 85% CB | 70% CB |

Sensory evaluation

| | | | | | |
|---|---|---|---|---|---|
| Meltdown | A | B | C | A | B |

The sensory evaluation in Table 6 clearly demonstrates that an increase in CBI content in the chocolate fat phase impacts the overall meltdown of the dark chocolate application. However, the meltdown for the chocolate with 30% substitution of cocoa butter with CBI VIII has still an acceptable meltdown.

### Example 4—Shelf Life Evaluation

The shelf life results are given in Table 7. The shelf life results demonstrate that it is possible to make a chocolate comprising CBI based on blends of either Shea Stearin and Sal oil or Shea oil and Sal Stearin with a shelf life performance at least as good as cocoa butter based chocolate when stored at 20° C. However, the higher content of the sum of StOSt and StOA for the CBI's as compared to cocoa butter results in more heat stable chocolates with respect to shelf life when stored at 25° C.

TABLE 7

| Chocolate reference and chocolates with CBI's | | | | |
|---|---|---|---|---|
| | 15% | 30% | 15% | 30% |
| Cocoa | CBI I + | CBI I + | CBI VIII + | CBI VIII + |
| Butter | 85% CB | 70% CB | 85% CB | 70% CB |

Bloom Stability

| | | | | | |
|---|---|---|---|---|---|
| Weeks before strong | >52 | >52 | >52 | >52 | >52 |
| bloom at 20° C. | | | | | |
| isothermal storage | | | | | |
| Weeks before strong | 10 | 15 | 20 | 14 | 18 |
| bloom at 25° C. | | | | | |
| isothermal storage | | | | | |

1. A fat composition comprising a vegetable fat phase, wherein the vegetable fat phase comprises:
from 85.0% to 100.0% by weight of triglycerides compared to the total weight of the vegetable fat phase;
from 50.0% to 85.0% by weight of SatOSat+SatSatO triglycerides compared to the total weight of triglycerides in the vegetable fat phase;
from 40.0 to 65.0% by weight of StOSt+StStO triglycerides compared to the total weight of triglycerides in the vegetable fat phase;
4.0% or less by weight of POP+PPO triglycerides compared to the total weight of triglycerides in the vegetable fat phase;
from 4.0% to 13.0% by weight of StOA+StAO+AStO triglycerides compared to the total weight of triglycerides in the vegetable fat phase;
from 2.0% to 6.0% by weight of StLiSt+StStLi triglycerides compared to the total weight of triglycerides in the vegetable fat phase; and
a ratio of the weight of SatSatO triglycerides to the weight of SatOSat triglycerides of 0.10 or less;
wherein the vegetable fat phase is free from palm oil and/or fractions thereof;
wherein the vegetable fat phase originates from at least two different vegetable fat sources; and
wherein Sat is saturated fatty acids selected from C16-, C18-, C20-, C22-, and/or C24-fatty acids, P is palmitic acid (C16:0), St is steric acid (C18:0), O is oleic acid (C18:1), A is arachidic acid (C20:0), and Li is linoleic acid (C18:2).

2. The fat composition according to claim 1, wherein the vegetable fat phase is free from enzymatic interesterified components.

3. The fat composition according to claim 1, wherein the vegetable fat phase comprises from 95.0% to 99.0% by weight of triglycerides compared to the total weight of the vegetable fat phase.

4. The fat composition according to claim 1, wherein the vegetable fat phase comprises from 55.0% to 82.0% by weight of SatOSat+SatSatO triglycerides compared to the total weight of triglycerides in the vegetable fat phase.

5. The fat composition according to claim 1, wherein the vegetable fat phase comprises from 42.0% to 63.0% by weight of StOSt+StStO triglycerides compared to the total weight of triglycerides in the vegetable fat phase.

6. The fat composition according to claim 1, wherein the vegetable fat phase comprises 3.0% or less by weight of POP+PPO triglycerides compared to the total weight of triglycerides in the vegetable fat phase.

7. The fat composition according to claim 1, wherein the vegetable fat phase further comprises from 4.0% to 15.0% by weight of POSt+PStO+StPO triglycerides compared to the total weight of triglycerides in the vegetable fat phase.

8. The fat composition according to claim 1, wherein the vegetable fat phase comprises from 5.0% to 12.0% by weight of StOA+StAO+AStO triglycerides compared to the total weight of triglycerides in the vegetable fat phase.

9. The fat composition according to claim 1, wherein the vegetable fat phase comprises from 2.2% to 5.8% by weight of StLiSt+StStLi triglycerides compared to the total weight of triglycerides in the vegetable fat phase.

10. The fat composition according to claim 1, wherein the ratio in the vegetable fat phase of the weight of SatSatO triglycerides to the weight of SatOSat triglycerides is 0.07 or less.

11. The fat composition according to claim 1, wherein the ratio in the vegetable fat phase of the weight of SatSatO triglycerides to the weight of SatOSat triglycerides is from 0.00 to 0.10.

12. The fat composition according to claim 1, wherein the at least two different vegetable fat sources are composed of at least a first vegetable fat source and a second vegetable fat source; wherein the first vegetable fat source is originating from Shea oil and/or fractions thereof; and wherein the second vegetable fat source is originating from Sal oil and/or fractions thereof.

13. The fat composition according to claim 12, wherein the first vegetable fat source is originating from Shea oil; and wherein the second vegetable fat source is originating from Sal oil and/or fractions thereof.

14. The fat composition according to claim 12, wherein the first vegetable fat source is originating from Shea oil and/or fractions thereof; and wherein the second vegetable fat source is originating from Sal oil.

15. The fat composition according to claim 12, wherein the first vegetable fat source is originating from Shea oil; and wherein the second vegetable fat source is originating from Sal stearin.

16. The fat composition according to claim 12, wherein the first vegetable fat source is originating from Shea stearin; and wherein the second vegetable fat source is originating from Sal oil.

17. The fat composition according to claim 12, wherein the first vegetable fat source is in an amount from 30% to 70% by weight of the sum of the first vegetable fat source and the second vegetable fat source.

18. The fat composition according to claim 12, wherein the second vegetable fat source is in an amount from 30% to 70% by weight of the sum of the first vegetable fat source and the second vegetable fat source.

19. The fat composition according to claim 1, wherein the vegetable fat phase originates from and consists of two different vegetable fat sources.

20. The fat composition according to claim 1, wherein the fat composition is a cocoa butter improver (CBI) composition.

21. (canceled)

22. A confectionary or chocolate or chocolate-like product having a fat content from 20% to 60% by weight, where the fat content comprises from 5 to 50% by weight of a fat composition according to claim 1 compared to the total weight of the fat content.

23. The confectionary or chocolate or chocolate-like product according to claim 22, wherein the fat content comprises from 10% to 40% by weight of the fat composition compared to the total weight of the fat content.

24. A process for the preparation of a fat composition according to claim 12, wherein the first vegetable fat source is blended with the second vegetable fat source to obtain the fat composition.
